(19) United States
(12) Patent Application Publication
(10) Pub. No.: US 2004/0025661 A1
(43) Pub. Date: Feb. 12, 2004

(54) Device for stripping flat ribbon cables

(76) Inventor: Leo Buhler, Wadenswil (CH)

Correspondence Address: M Robert Kestenbaum, 11011 Bermuda Dunes NE, Albuqueruqe, NM, 87111, US

(21) Appl. No.: 10/311,984

(22) PCT Filed: Jun. 19, 2001
(86) PCT No.: PCT/CH01/00384

(30) Foreign Application Priority Data
Jun. 23, 2000 (CH) 1250/00

(51) Int. Cl. B26D 3/00; B26D 1/14

(52) U.S. Cl. 83/861; 83/471.1; 83/477.2

(57) ABSTRACT

An apparatus is proposed which makes it possible to produce contact windows only for one conductor track or a plurality of individual conductor tracks in the flat cable. The other conductor tracks should not be influenced or impaired. A flat cable is transported in a guide channel through the apparatus. For each conductor track of a flat cable, a cutting disk is present above and a pressure element below. As soon as insulation is to be stripped from an area, the actuating element is actuated and the pressure element is raised. As a result, the flat cable is pressed with the insulated conductor track against the cutting disk and the insulation layer above the conductor track is removed.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates to an apparatus for partially stripping insulation from flat cables, according to the preamble of the independent patent claim.

### TECHNICAL FIELD

Various systems for the insulation stripping process for flat cables are known on the market. Stripping insulation from ends of flat cables does not present any major problems and has long been carried out. There has for some time been a need for producing so-called contact windows within the length of flat cables, in order to permit intermediate connections. For the production of such contact windows, it is necessary to be able to remove the insulation layer on one side, i.e. on one surface, at a desired point on a flat cable within its total length. Stripping insulation from one side ensures that the conductor tracks remain clearly separated from one another and insulated from one another. Various possibilities are known for this purpose. For example, the insulation layer is ground off on one side. This is a simple and cheap method. This method has the disadvantage that the insulation material is generally overheated and begins to melt. In addition, the conductor tracks may be damaged by the action of heat. A further possibility consists in the application of ultrasound. The application of ultrasound to one surface of the flat cable always also influences the insulation on the opposite side and in the spaces between the conductor tracks. A further possibility is the action of a focused CO₂ laser. However, this method is very slow. Insulation residues and vapors which are hazardous to health result. In all these methods, a window is opened up and insulation stripped transversely over the entire flat cable.

### SUMMARY OF THE INVENTION

It is an object of the invention to provide an apparatus which makes it possible to produce contact windows only for one or more individual conductor tracks in the flat cable. The remaining conductor tracks must not be influenced or impaired.

This object is achieved by an apparatus for partially stripping insulation from flat cables having a number of conductors, comprising an insulation stripping element, baseplate and a cable guide and comprising drive means for transporting the flat cable through, wherein the cable guide consists of the baseplate and top plate arranged above this, a guide channel being present between these two, through which a flat cable is transported in the longitudinal direction, and wherein the top plate has a slot in the region of each conductor track of the transported flat cable, one rotating cutting disk or one stationary plane iron each projecting downward through each of these slots to at least the underside of the top plate, and wherein and the baseplate likewise has a slot in the region of each conductor track of the transported flat cable, one pressure element each being present and displaceable through each of these slots in the baseplate.

### BRIEF DESCRIPTION OF THE DRAWINGS

The invention is described below in relation to the drawings.

FIG. 1 shows a longitudinal section through the apparatus according to the invention, in the processing region, and

FIG. 2 shows a cross-section at the same point.

### DETAILED DESCRIPTION OF THE INVENTION

The novel apparatus makes it possible to produce contact windows only for one or more individual conductor tracks in the flat cable. The remaining conductor tracks are not influenced or impaired. A flat cable is transported in a guide channel through the apparatus. For each conductor track of a flat cable, a cutting disk is present above and a pressure element below. As soon as insulation is to be stripped from an area, the actuating element is actuated and the pressure element is raised. Consequently, the flat cable with the insulated conductor track is pressed against the cutting disk and the insulation layer above the conductor track is removed.

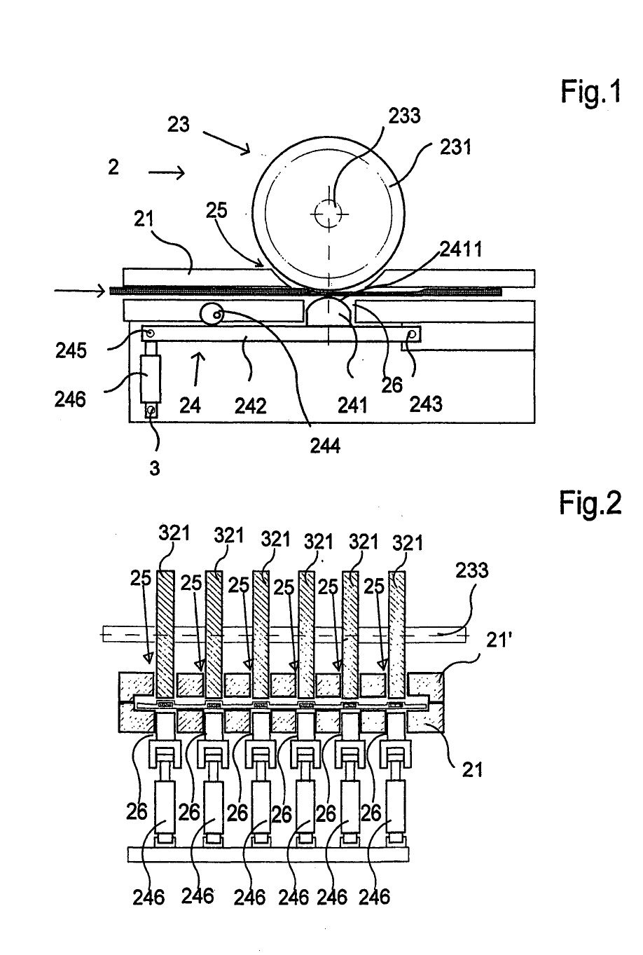

The apparatus according to the invention and shown in FIG. 1 is suitable for partially stripping insulation from flat cables 1 having a number of conductors, particularly for producing contact windows in which insulation is stripped on one side. A flat cable 1 is placed on a baseplate 21 with a cable guide. It is transported by drive means on the baseplate 21 through the apparatus for insulation stripping. The transport may be effected continuously or stepwise. In the region of the actual apparatus for insulation stripping, the cable guide consists of the baseplate 21 and top plate 21′ arranged above it. Present between these is the guide channel 22 through which a flat cable 1 is transported in the longitudinal direction. The top plate 21′ has a slot 213 in the longitudinal direction in the region of each conductor track of the transported flat cable. A rotating cutting disk 231 or a stationary plane iron 231′ passes through each of these slots 213. They project downward from above through the slots at least to the underside of the top plate 21′. In the region of each conductor track of the transported flat cable, the baseplate 21 is likewise provided with one slot 214 each. One pressure element 241 each can be moved through each of these slots 214 in the baseplate 21.

Each pressure element 241 is arranged on a separate pressure mechanism. It is provided with an upwardly curved contact surface 2411. Each of the pressure elements 241 can be moved upward from a lower rest position into an operating position through the slot 214 in the baseplate 21. In the rest position, the pressure element 241 is present below the surface of the baseplate 21 and hence the contact surface 2411 is present below the region in which the flat cable 1 is drawn through. The contact surface 2411 is designed so that it generates as little friction as possible against the flat cable. For this purpose, it can be provided with a suitable coating.

Each pressure mechanism 24 furthermore has an actuating element 246. This may be a hydraulic or pneumatic or electrical actuating elements [sic]. The object of each actuating element 246 is to raise the pressure element in a controlled manner at the correct time so that the flat cable 1 in the guide channel 22 is pressed against the rotating cutting disk 231 or against the stationary plane iron 232. The insulation layer above the conductor track is then planed away or cut away. In the example shown, the actuating element 246 moves a lever arm 242, which is pivotably fastened at one end by a pivot joint 243 to the apparatus.

For exact limitation of the lifting movement of the pressure element, an adjustable stop 244 of a known type is provided. A cam or an adjusting screw may be mentioned as examples for many possibilities for the adjustable stop 244. The stop is adjustable so that the rotating cutter 231 or the stationary plane iron 232 just removes the insulation layer above the conductor track without impairing or even damaging the conductor track itself.

The actuating element may of course also be an electromagnet, a piezoelectric element or a magnetostrictive element. Particularly when such an actuating element 24 is used, it is even possible to dispense with the lever arm, and the pressure element 241 can be acted on directly.

A very particular type of lever arm is obtained by using a memory alloy for its production. Through the spontaneous transfer from lowered to raised state, a lever arm obtained from a memory alloy makes it possible to achieve a very short reaction time of the pressure mechanism 24, which can lead to an extremely precise beginning and end of the insulation stripping process on the individual conductor track.

From the cross-section according to FIG. 2, the manner in which the guide channel 22 is formed by the support plate 21 and the top plate 21′ is clearly evident. The flat cable 1 is thus guided satisfactorily and with correct alignment. The various conductor tracks are arranged at regular intervals from one another in the flat cable 1. The slots 213 in the top plate 21′ and the slots 214 in the support plate 21 are located exactly at the same intervals. The cutter 23 is present above the top plate 21′. It consists of a corresponding number of rotating cutting disks 231 which are fastened a distance apart from one another on a common drive shaft 233. Each cutting disk 233 [sic] projects into the respective slot 213 in the top plate 21′, and does so to such an extent that it projects downward slightly below the underside of the top plate 21′. The cutter can be adjusted in distance relative to the top plate, in order to be able to compensate wear of the rotating cutting disks 231.

Instead of the rotating disks 231, a plane unit may also be arranged on the top plate 21′. Said plane unit has a number of stationary plane irons 232. Each plane iron 232 projects through one of the slots 213 in the top plate 21′ and extends slightly below said top plate. The plane irons are as far as possible likewise mounted so as to be adjustable in their height.

The pressure mechanisms 24 with actuating elements 246 are present below the support plate 21. One pressure element 241 each projects into each slot 214 of the baseplate. The interaction of the pressure elements 241 with the rotating cutting disks 231 is clearly shown in this diagram.

The actuation of the actuating elements 246 and hence the raising and lowering of the pressure elements 241 are effected by means of suitable regulation as a function of the actual position of the flat cable or of the transport velocity when the flat cable is drawn through the apparatus for insulation stripping.

This actuation is preferably supplemented by cutter monitoring. Cutter monitoring prevents material of the conductor track itself being removed and said conductor tracks from being impaired or even damaged in any way. This can be effected by automatic adjustment of the stops 244. The monitoring can be carried out in a very simple manner by subjecting the conductor to tension and monitoring this tension.

1. An apparatus for partially stripping insulation from flat cables (1) having a number of conductors, comprising an insulation stripping element, baseplate (21) and a cable guide and comprising drive means for transporting the flat cable through, wherein the cable guide consists of the baseplate (21) and top plate (21′) arranged above this, a guide channel (22) being present between these two, through which a flat cable (1) is transported in the longitudinal direction, and wherein the top plate (21′) has a slot (213) in the region of each conductor track of the transported flat cable, one rotating cutting disk (231) or one stationary plane iron (231′) each projecting downward through each of these slots (213) to at least the underside of the top plate (21′), and wherein and [sic] the baseplate (21) likewise has a slot (214) in the region of each conductor track of the transported flat cable, one pressure element (231) [sic] each being present and displaceable through each of these slots (214) in the baseplate (21).

2. The apparatus as claimed in claim 1, wherein each pressure element (241) can be moved upward from a lower rest position, in which the pressure element (241) is present below the surface of the baseplate, into an operating position through the slot (214) in the baseplate.

3. The apparatus as claimed in claim 2, wherein one pressure mechanism (24) having an actuating element (246) is present for each pressure element (241).

4. The apparatus as claimed in claim 2, wherein an adjustable stop (244) for limiting the lifting movement of the pressure element (241) is present for each pressure mechanism (24).

5. The apparatus as claimed in claim 2, wherein all rotating cutting disks (231) are fastened on a common drive shaft (233).

6. The apparatus as claimed in claim 2, wherein the pressure elements (241) have a contact surface (241′) designed for low friction.

7. The apparatus as claimed in claim 3, wherein each actuating element (246) is individually controllable.

8. The apparatus as claimed in claim 7, wherein the actuating elements (246) are controllable as a function of the transport velocity of the flat cable.
